(19) United States
(12) Patent Application Publication
(10) Pub. No.: US 2026/0270166 A1
(43) Pub. Date: Sep. 10, 2026

(54) SYSTEM FOR DYNAMIC PRESCHEDULING ON TELECOMMUNICATION NETWORKS

(71) Applicant: T-Mobile USA, Inc., Bellevue, WA (US)

(72) Inventors: Roopesh Kumar Polaganga, Bothell, WA (US); Sanjay Waje, Frisco, TX (US); Sai Preetham Kumar Bandi, Redmond, WA (US)

(21) Appl. No.: 19/071,136

(22) Filed: Mar. 5, 2025

(51) Int. Cl. H04L 41/5009; H04L 41/16; H04W 72/04

(52) U.S. Cl. CPC H04L 41/5009; H04L 41/16; H04W 72/04

(57) ABSTRACT

The system receives network state data from a base station of a telecommunication network. The network state data includes environmental conditions, wireless device characteristics, a network configuration, or a key performance indicator (KPI). The KPI includes at least one of uplink received signal strength indicator, latency, or call drop rate. The system causes the network state data to be inputted into a machine learning (ML) model. The system receives, from the ML model, at least one prescheduling parameter. The at least one prescheduling parameter defines a network resource allocation of the base station. The system generates, using the ML model, a prediction indicating an effect on the KPI caused by implementing the at least one prescheduling parameter. The system modifies the at least one prescheduling parameter based on the predicted effect. The system implements the at least one prescheduling parameter to preschedule network resources on the base station.

### BACKGROUND

5G networks represent a significant advancement in wireless communication technology, offering enhanced capabilities for both consumer and enterprise applications. Prescheduling mechanisms in 5G networks were introduced to improve uplink performance by proactively allocating transmission resources to user equipment (UE). These systems operate by issuing uplink grants on the Physical Downlink Control Channel (PDCCH) before actual data transmission requests are received. However, traditional implementations typically utilize fixed parameters and rule-based allocation strategies to manage network resources, which can lead to a lower quality of service.

### BRIEF DESCRIPTION OF THE DRAWINGS

Detailed descriptions of implementations of the present invention will be described and explained through the use of the accompanying drawings.

FIG. 1 is a block diagram that illustrates a wireless communications system that can implement aspects of the present technology.

FIG. 2 is a block diagram that illustrates 5G core network functions (NFs) that can implement aspects of the present technology.

FIG. 3 is a flowchart that illustrates an embodiment of the system.

FIG. 4 is a flowchart that illustrates an embodiment of the system.

FIG. 5 is a block diagram that illustrates components of a computing device.

FIG. 6 is a block diagram illustrating an example machine learning system, in accordance with one or more embodiments.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

The disclosed technology relates to a system for adaptive prescheduling in telecommunication networks to improve key performance indicators (KPIs) while providing telecommunication services. Prescheduling proactively allocates uplink grants to user devices to provide a more streamlined user experience. However, conventional systems use static prescheduling to assign resources to different frequencies or slices of the telecommunication network. While static prescheduling aims to improve network performance, its implementation presents complex trade-offs that affect overall network efficiency and user experience. Static prescheduling involves allocating resources based on an expected demand to improve KPIs related to uplink latency and jitter reduction. Because resources are allocated based on demand, static prescheduling can lead to unexpected impacts to certain KPIs, such as increased uplink received signal strength indicator (RSSI), increased end-to-end disconnection rate, decreased spectral efficiency, and increased resource constraints. Static prescheduling does not provide a means for analyzing impacts to KPIs in order to prevent or counteract user experience issues caused by varying network conditions.

The disclosed system implements a machine learning (ML) model to adjust prescheduling parameters at a base station based on network conditions and device characteristics. The system collects state data at the base station, including, for example, uplink Expand RSSI levels, latency metrics, congestion indicators, and/or device profiles, to determine the current state of the base station. The system inputs the state data into a specifically trained ML model to determine how the network resources should be allocated. The ML model can be trained with historical network data and/or a specifically generated training dataset. The ML model can improve KPIs such as reduced uplink interference, improved latency, and/or lower disconnection rates. The ML model outputs prescheduling parameters to modify the allocation of resources on the base station. Based on the ML model's output, the base station dynamically adjusts the resource prescheduling, such as adjusting which devices receive prescheduled grants, the frequency of prescheduling, and/or the amount of resources allocated. The system can also enable or disable prescheduling for specific quality of service (QoS) classes, device types, and/or network slices or gradually adjust parameters in small increments to avoid sudden performance changes.

After applying the prescheduling parameters, the system monitors the resulting impact on network KPIs. The observed KPI changes enable the system to refine the decision-making process continually. The method repeats this cycle at regular intervals, such as every 5, 10, and/or 15 minutes, to maintain optimal prescheduling settings as network conditions evolve. Additionally, the system can revert prescheduling changes if the changes cause an unexpected performance degradation.

Therefore, the system offers improvements over static prescheduling by dynamically allocating resources to optimize latency and jitter KPIs while preventing negative impacts on other KPIs related to user experience. The allocation of resources through dynamic prescheduling based on actual network conditions and wireless device requirements leads to improved spectral efficiency and reduced interference. Additionally, the system's ability to make gradual, validated adjustments ensures network stability while continuously improving performance, while the continuous monitoring and adjusting of network resources enables proactive issue resolution and long-term optimization of network resources.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail, to avoid unnecessarily obscuring the descriptions of examples.

### Wireless Communications System

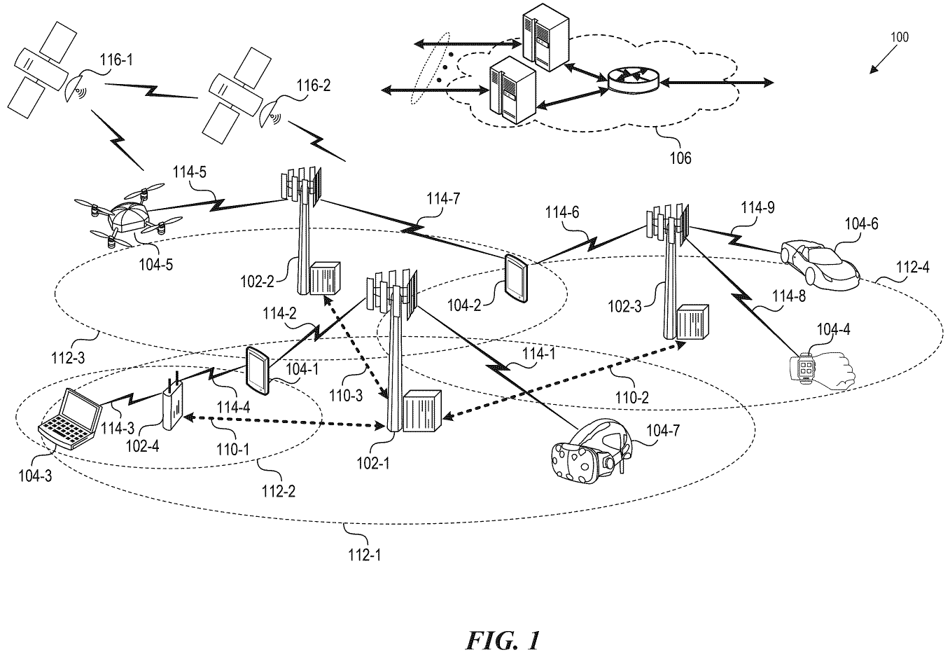

FIG. 1 is a block diagram that illustrates a wireless telecommunication network 100 (“network 100”) in which aspects of the disclosed technology are incorporated.
The network 100 includes base stations 102-1 through 102-4 (also referred to individually as “base station 102” or collectively as “base stations 102”). A base station is a type of network access node (NAN) that can also be referred to as a cell site, a base transceiver station, or a radio base station. The network 100 can include any combination of NANs including an access point, radio transceiver, gNodeB (gNB), NodeB, eNodeB (eNB), Home NodeB or Home eNodeB, or the like. In addition to being a wireless wide area network (WWAN) base station, a NAN can be a wireless local area network (WLAN) access point, such as an Institute of Electrical and Electronics Engineers (IEEE) 802.11 access point.

The NANs of a network 100 formed by the network 100 also include wireless devices 104-1 through 104-7 (referred to individually as “wireless device 104” or collectively as “wireless devices 104”) and a core network 106. The wireless devices 104 can correspond to or include network 100 entities capable of communication using various connectivity standards. For example, a 5G communication channel can use millimeter wave (mmW) access frequencies of 28 GHz or more. In some implementations, the wireless device 104 can operatively couple to a base station 102 over a long-term evolution/long-term evolution-advanced (LTE/LTE-A) communication channel, which is referred to as a 4G communication channel.

The core network 106 provides, manages, and controls security services, user authentication, access authorization, tracking, internet protocol (IP) connectivity, and other access, routing, or mobility functions. The base stations 102 interface with the core network 106 through a first set of backhaul links (e.g., S1 interfaces) and can perform radio configuration and scheduling for communication with the wireless devices 104 or can operate under the control of a base station controller (not shown). In some examples, the base stations 102 can communicate with each other, either directly or indirectly (e.g., through the core network 106), over a second set of backhaul links 110-1 through 110-3 (e.g., X1 interfaces), which can be wired or wireless communication links.

The base stations 102 can wirelessly communicate with the wireless devices 104 via one or more base station antennas. The cell sites can provide communication coverage for geographic coverage areas 112-1 through 112-4 (also referred to individually as “coverage area 112” or collectively as “coverage areas 112”). The coverage area 112 for a base station 102 can be divided into sectors making up only a portion of the coverage area (not shown). The network 100 can include base stations of different types (e.g., macro and/or small cell base stations). In some implementations, there can be overlapping coverage areas 112 for different service environments (e.g., Internet of Things (IoT), mobile broadband (MBB), vehicle-to-everything (V2X), machine-to-machine (M2M), machine-to-everything (M2X), ultra-reliable low-latency communication (URLLC), machine-type communication (MTC), etc.).

The network 100 can include a 5G network 100 and/or an LTE/LTE-A or other network. In an LTE/LTE-A network, the term “eNBs” is used to describe the base stations 102, and in 5G new radio (NR) networks, the term “gNBs” is used to describe the base stations 102 that can include mmW communications. The network 100 can thus form a heterogeneous network 100 in which different types of base stations provide coverage for various geographic regions. For example, each base station 102 can provide communication coverage for a macro cell, a small cell, and/or other types of cells. As used herein, the term “cell” can relate to a base station, a carrier or component carrier associated with the base station, or a coverage area (e.g., sector) of a carrier or base station, depending on context.

A macro cell generally covers a relatively large geographic area (e.g., several kilometers in radius) and can allow access by wireless devices that have service subscriptions with a wireless network 100 service provider. As indicated earlier, a small cell is a lower-powered base station, as compared to a macro cell, and can operate in the same or different (e.g., licensed, unlicensed) frequency bands as macro cells. Examples of small cells include pico cells, femto cells, and micro cells. In general, a pico cell can cover a relatively smaller geographic area and can allow unrestricted access by wireless devices that have service subscriptions with the network 100 provider. A femto cell covers a relatively smaller geographic area (e.g., a home) and can provide restricted access by wireless devices having an association with the femto unit (e.g., wireless devices in a closed subscriber group (CSG), wireless devices for users in the home). A base station can support one or multiple (e.g., two, three, four, and the like) cells (e.g., component carriers). All fixed transceivers noted herein that can provide access to the network 100 are NANs, including small cells.

The communication networks that accommodate various disclosed examples can be packet-based networks that operate according to a layered protocol stack. In the user plane, communications at the bearer or Packet Data Convergence Protocol (PDCP) layer can be IP-based. A Radio Link Control (RLC) layer then performs packet segmentation and reassembly to communicate over logical channels. A Medium Access Control (MAC) layer can perform priority handling and multiplexing of logical channels into transport channels. The MAC layer can also use Hybrid ARQ (HARQ) to provide retransmission at the MAC layer, to improve link efficiency. In the control plane, the Radio Resource Control (RRC) protocol layer provides establishment, configuration, and maintenance of an RRC connection between a wireless device 104 and the base stations 102 or core network 106 supporting radio bearers for the user plane data. At the Physical (PHY) layer, the transport channels are mapped to physical channels.

Wireless devices can be integrated with or embedded in other devices. As illustrated, the wireless devices 104 are distributed throughout the network 100, where each wireless device 104 can be stationary or mobile. For example, wireless devices can include handheld mobile devices 104-1 and 104-2 (e.g., smartphones, portable hotspots, tablets, etc.); laptops 104-3; wearables 104-4; drones 104-5; vehicles with wireless connectivity 104-6; head-mounted displays with wireless augmented reality/virtual reality (AR/VR) connectivity 104-7; portable gaming consoles; wireless routers, gateways, modems, and other fixed-wireless access devices; wirelessly connected sensors that provide data to a remote server over a network; IoT devices such as wirelessly connected smart home appliances; etc.

A wireless device (e.g., wireless devices 104) can be referred to as a user equipment (UE), a customer premises equipment (CPE), a mobile station, a subscriber station, a mobile unit, a subscriber unit, a wireless unit, a remote unit, a handheld mobile device, a remote device, a mobile subscriber station, a terminal equipment, an access terminal, a mobile terminal, a wireless terminal, a remote terminal, a handset, a mobile client, a client, or the like.

A wireless device can communicate with various types of base stations and network 100 equipment at the edge of a network 100 including macro eNBs/gNBs, small cell eNBs/gNBs, relay base stations, and the like. A wireless device can also communicate with other wireless devices either within or outside the same coverage area of a base station via device-to-device (D2D) communications.

The communication links 114-1 through 114-9 (also referred to individually as “communication link 114” or collectively as “communication links 114”) shown in network 100 include uplink (UL) transmissions from a wireless device 104 to a base station 102 and/or downlink (DL) transmissions from a base station 102 to a wireless device 104. The downlink transmissions can also be called forward link transmissions while the uplink transmissions can also be called reverse link transmissions. Each communication link 114 includes one or more carriers, where each carrier can be a signal composed of multiple sub-carriers (e.g., waveform signals of different frequencies) modulated according to the various radio technologies. Each modulated signal can be sent on a different sub-carrier and carry control information (e.g., reference signals, control channels), overhead information, user data, etc. The communication links 114 can transmit bidirectional communications using frequency division duplex (FDD) (e.g., using paired spectrum resources) or time division duplex (TDD) operation (e.g., using unpaired spectrum resources). In some implementations, the communication links 114 include LTE and/or mmW communication links.

In some implementations of the network 100, the base stations 102 and/or the wireless devices 104 include multiple antennas for employing antenna diversity schemes to improve communication quality and reliability between base stations 102 and wireless devices 104. Additionally or alternatively, the base stations 102 and/or the wireless devices 104 can employ multiple-input, multiple-output (MIMO) techniques that can take advantage of multi-path environments to transmit multiple spatial layers carrying the same or different coded data.

In some examples, the network 100 implements 6G technologies including increased densification or diversification of network nodes. The network 100 can enable terrestrial and non-terrestrial transmissions. In this context, a Non-Terrestrial Network (NTN) is enabled by one or more satellites, such as satellites 116-1 and 116-2, to deliver services anywhere and anytime and provide coverage in areas that are unreachable by any conventional Terrestrial Network (TN). A 6G implementation of the network 100 can support terahertz (THz) communications. This can support wireless applications that demand ultra-high quality of service (QoS) requirements and multi-terabits-per-second data transmission in the era of 6G and beyond, such as terabit-per-second backhaul systems, ultra-high-definition content streaming among mobile devices, AR/VR, and wireless high-bandwidth secure communications. In another example of 6G, the network 100 can implement a converged Radio Access Network (RAN) and Core architecture to achieve Control and User Plane Separation (CUPS) and achieve extremely low user plane latency. In yet another example of 6G, the network 100 can implement a converged Wi-Fi and Core architecture to increase and improve indoor coverage.

### 5G Core Network Functions

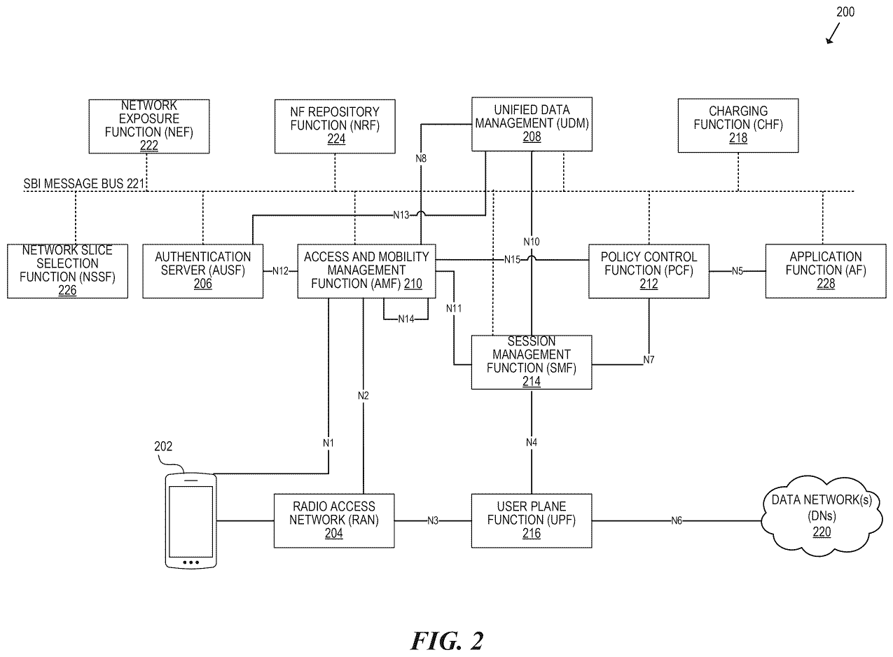

FIG. 2 is a block diagram that illustrates an architecture 200 including 5G core network functions (NFs) that can implement aspects of the present technology. A wireless device 202 can access the 5G network through a NAN (e.g., gNB) of a RAN 204. The NFs include an Authentication Server Function (AUSF) 206, a Unified Data Management (UDM) 208, an Access and Mobility management Function (AMF) 210, a Policy Control Function (PCF) 212, a Session Management Function (SMF) 214, a User Plane Function (UPF) 216, and a Charging Function (CHF) 218.

The interfaces N1 through N15 define communications and/or protocols between each NF as described in relevant standards. The UPF 216 is part of the user plane and the AMF 210, SMF 214, PCF 212, AUSF 206, and UDM 208 are part of the control plane. One or more UPFs can connect with one or more data networks (DNs) 220. The UPF 216 can be deployed separately from control plane functions. The NFs of the control plane are modularized such that they can be scaled independently. As shown, each NF service exposes its functionality in a Service Based Architecture (SBA) through a Service Based Interface (SBI) 221 that uses HTTP/2. The SBA can include a Network Exposure Function (NEF) 222, an NF Repository Function (NRF) 224, a Network Slice Selection Function (NSSF) 226, and other functions such as a Service Communication Proxy (SCP).

The SBA can provide a complete service mesh with service discovery, load balancing, encryption, authentication, and authorization for interservice communications. The SBA employs a centralized discovery framework that leverages the NRF 224, which maintains a record of available NF instances and supported services. The NRF 224 allows other NF instances to subscribe and be notified of registrations from NF instances of a given type. The NRF 224 supports service discovery by receipt of discovery requests from NF instances and, in response, details which NF instances support specific services.

The NSSF 226 enables network slicing, which is a capability of 5G to bring a high degree of deployment flexibility and efficient resource utilization when deploying diverse network services and applications. A logical end-to-end (E2E) network slice has pre-determined capabilities, traffic characteristics, and service-level agreements and includes the virtualized resources required to service the needs of a Mobile Virtual Network Operator (MVNO) or group of subscribers, including a dedicated UPF, SMF, and PCF. The wireless device 202 is associated with one or more network slices, which all use the same AMF. A Single Network Slice Selection Assistance Information (S-NSSAI) function operates to identify a network slice. Slice selection is triggered by the AMF, which receives a wireless device registration request. In response, the AMF retrieves permitted network slices from the UDM 208 and then requests an appropriate network slice of the NSSF 226.

The UDM 208 introduces a User Data Convergence (UDC) that separates a User Data Repository (UDR) for storing and managing subscriber information. As such, the UDM 208 can employ the UDC under 3GPP TS 22.101 to support a layered architecture that separates user data from application logic. The UDM 208 can include a stateful message store to hold information in local memory or can be stateless and store information externally in a database of the UDR. The stored data can include profile data for subscribers and/or other data that can be used for authentication purposes. Given a large number of wireless devices that can connect to a 5G network, the UDM 208 can contain voluminous amounts of data that is accessed for authentication. Thus, the UDM 208 is analogous to a Home Subscriber Server (HSS) and can provide authentication credentials while being employed by the AMF 210 and SMF 214 to retrieve subscriber data and context.

The PCF 212 can connect with one or more Application Functions (AFs) 228. The PCF 212 supports a unified policy framework within the 5G infrastructure for governing network behavior. The PCF 212 accesses the subscription information required to make policy decisions from the UDM 208 and then provides the appropriate policy rules to the control plane functions so that they can enforce them. The SCP (not shown) provides a highly distributed multi-access edge compute cloud environment and a single point of entry for a cluster of NFs once they have been successfully discovered by the NRF 224. This allows the SCP to become the delegated discovery point in a datacenter, offloading the NRF 224 from distributed service meshes that make up a network operator's infrastructure. Together with the NRF 224, the SCP forms the hierarchical 5G service mesh.

The AMF 210 receives requests and handles connection and mobility management while forwarding session management requirements over the N11 interface to the SMF 214. The AMF 210 determines that the SMF 214 is best suited to handle the connection request by querying the NRF 224. That interface and the N11 interface between the AMF 210 and the SMF 214 assigned by the NRF 224 use the SBI 221. During session establishment or modification, the SMF 214 also interacts with the PCF 212 over the N7 interface and the subscriber profile information stored within the UDM 208. Employing the SBI 221, the PCF 212 provides the foundation of the policy framework that, along with the more typical QoS and charging rules, includes network slice selection, which is regulated by the NSSF 226.

### Dynamic Prescheduling

The disclosed dynamic prescheduling system for telecommunication networks improves key performance indicators (KPIs) while providing low-latency services. Prescheduling proactively allocates uplink grants to wireless devices to reduce latency and jitter. However, static prescheduling approaches can negatively impact other KPIs, such as uplink interference and disconnection rates. Additionally, static prescheduling can lead to wasted resources when the resource demand does not meet the expected demand that was prescheduled. When resources are over-allocated to, for example, a specific frequency band or device characteristic, fewer resources are then available for other frequency bands or wireless devices. Having fewer resources available can cause a decrease in the user experience of wireless devices that do not have access to the allocated resources. Therefore, static prescheduling prevents access to resources, causing the base station and telecommunication network to waste resources and electricity.

The system disclosed herein implements a dynamic, machine learning-based approach to adjust prescheduling parameters in real time based on network conditions and device characteristics. The system can dynamically enable or disable prescheduling for specific devices, adjust the frequency of prescheduled grants, and modify resource allocation amounts based on real-time network data and learned patterns. The system can achieve improved overall performance compared to static prescheduling approaches, resulting in better user experiences for latency-sensitive applications while minimizing negative impacts on other aspects of network performance.

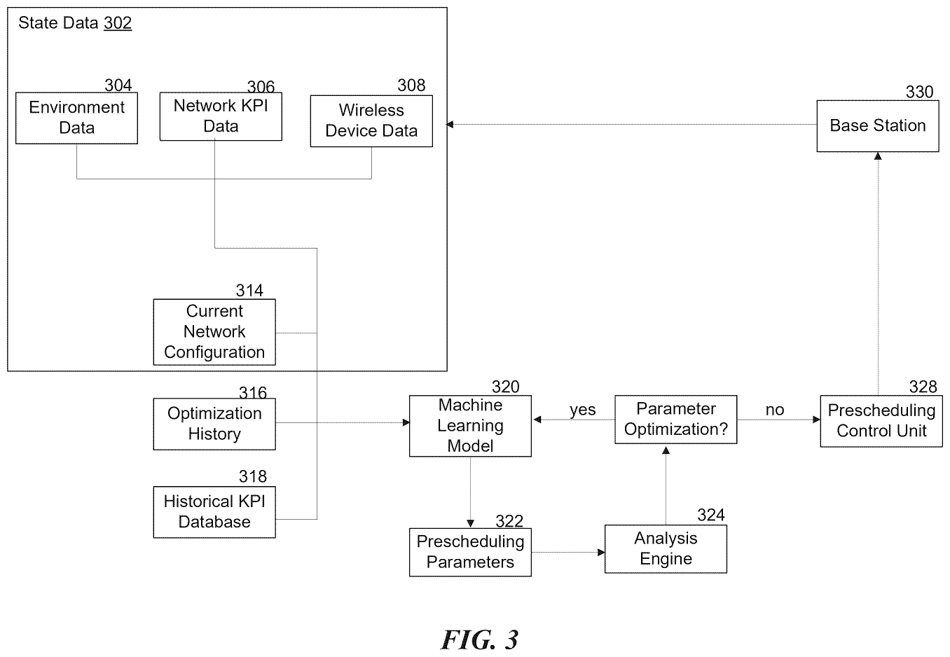

FIG. 3 illustrates an embodiment of the system for dynamically prescheduling network resources on base station 330 of a telecommunication network. The system dynamically preschedules network resources using ML model 320 and state data 302, optimization history 316, and/or the historical KPI database 318. The state data 302 includes data generated at the base station 330 within a recent predetermined interval (e.g., 5, 10, and/or 15 minutes). The state data 302 includes environment data 304, network KPI data 306, and/or wireless device data 308. Environment data 304 includes data related to the environmental factors or conditions surrounding the system and/or base station 330. For example, environmental data can include data relating to a current (e.g., within 1, 5, 10, and/or 15 minutes) temperature or weather and/or the existence of a power outage.

Network KPI data 306 relates to factors that affect the user experience of a wireless device connected to the base station 330. For example, network KPI data can include data relating to uplink RSSI levels, latency and jitter metrics, congestion indicators, call drop rates, network throughput, cell-edge performance, network stability, network traffic distribution across Quality-of-Service Class Identifiers (QCIs), and/or network topology and configuration. RSSI levels provide insight into the current interference conditions and signal quality in the uplink direction. Latency and jitter metrics indicate the current delay experienced by data packets traversing the network. Congestion indicators reflect the current load on network resources and help identify potential bottlenecks. Call drop rates serve as a measure of connection stability and overall network performance. Network throughput indicates the rate at which data is successfully delivered over a network connection. Cell-edge performance indicates the quality of the network signal experienced by wireless devices located at the outer boundary of a base station's coverage area. Network stability indicates a telecommunication network's ability to maintain a steady signal and data transfer rate without experiencing frequent disruptions, packet loss, or significant fluctuations in speed, ensuring smooth and uninterrupted communication between devices on the network. Network traffic distribution across QCIs is the observed traffic across priority levels, which is used to determine prescheduling needs. Network topology and configuration KPIs indicate which network elements or technologies are active and the total bandwidth of the base station.

Wireless device data 308 relates to different wireless device characteristics, types, capabilities, and/or current radio conditions (e.g., wireless signal strength). In some embodiments, the system can consider the type of application running on a device when determining prescheduling eligibility. For example, augmented reality (AR) or virtual reality (VR) applications can have different latency requirements compared to standard web browsing or messaging applications. In some embodiments, Reference Signal Received Power (RSRP) measurements are collected as part of the wireless device data 308. The system can use RSRP thresholds to determine prescheduling eligibility. Devices with lower RSRP values, indicating weaker signal strength, can potentially benefit more from prescheduling to compensate for challenging radio conditions.

In addition to the environment data 304, network KPI data 306, and wireless device data 308, state data 302 includes the current network configuration 314. The current network configuration 314 includes data that indicates how resources are currently allocated on the base station. For example, the current network configuration can indicate that a majority of resources are allocated to a specific frequency band or device type.

The optimization history 316 includes past prescheduling parameters including how past prescheduling parameters were adjusted after implementation. The optimization history 316 can also include how prescheduling parameters 322 were adjusted based on a first set of prescheduling parameters implemented on the base station 330. The historical KPI database 318 includes historical state data. The system can store and analyze past network performance data to identify trends and patterns. Historical information can help predict future network behavior and refine prescheduling strategies over time. In some embodiments, the historical KPI database 318 includes predetermined threshold KPI values.

The state data 302, the optimization history 316, and/or the historical KPI database 318 are inputted into the ML model 320 to enable the system to make informed decisions. The ML model 320 can be located on the base station 330, a different base station, multiple base stations, or a centralized server. By considering the different types of input data, the system can optimize the prescheduling parameters to balance low-latency requirements with overall network performance. The ML model 320 utilizes a reward function designed to simultaneously improve multiple key performance indicators (KPIs). The reward function aims to strike a balance between minimizing uplink interference and maintaining low latency for latency-sensitive applications. One of the primary KPIs that can be considered in the reward function is uplink interference, measured by uplink RSSI levels. The ML model 320 seeks to minimize the uplink interference to improve overall network performance and reduce the negative impact on neighboring base stations. By doing so, the system can potentially enhance spectral efficiency, which is another KPI factored into the reward calculation. The reward function can also take into account other performance metrics such as call drop rates, throughput, latency, spectral efficiency, and/or overall network stability. The ML model 320 strives to maintain low latency, particularly for applications that are sensitive to delays.

In some embodiments, the system assigns different weights to different KPIs on the relative importance of the KPI. For example, the system can assign higher importance to minimizing uplink interference in areas with dense cell deployment while prioritizing latency reduction in regions with a higher concentration of latency-sensitive applications. The system can be adaptive by adjusting the weights of different KPIs based on current network conditions or specific operational goals, enabling the system to prioritize different aspects of performance as needed, ensuring that the prescheduling strategy remains effective across varying network scenarios. For example, the ML model 320 can consider factors such as device type, capabilities, and current application usage when making prescheduling decisions. The ML model 320 can also consider network load and congestion when generating the prescheduling parameters 322. For instance, during periods of high network utilization, the ML model 320 can be more selective in the prescheduling decisions to avoid exacerbating congestion. Conversely, during periods of low utilization, the ML model 320 can be more generous with prescheduling to improve overall latency performance. Therefore, the system can optimize network performance while balancing the needs of different devices, applications, and network slices.

The ML model 320 outputs prescheduling parameters 322 based on the input data. The prescheduling parameters 322 can indicate how resources should be allocated on the base station 330. The prescheduling parameters 322 aim to improve KPIs while maintaining low latency for devices. The prescheduling parameters 322 can indicate which wireless devices should receive prescheduled grants, the frequency of prescheduling, and/or the amount of resources to allocate.

In some embodiments, the prescheduling parameters 322 can enable or disable prescheduling for specific quality of service (QoS) classes based the ML model 320 analyzing network conditions and determining which QoS classes would benefit most from prescheduling. For example, the prescheduling parameters 322 can enable prescheduling for QoS classes associated with latency-sensitive applications while disabling prescheduling for classes that do not require low latency. Similarly, the prescheduling parameters 322 can enable or disable prescheduling for specific network slices. Network slicing allows operators to create virtual networks tailored to different use cases. The system can adjust the prescheduling parameters 322 based on the requirements of each slice. For instance, a slice dedicated to industrial IoT applications can have different prescheduling parameters 322 compared to a slice for consumer mobile broadband. Additionally, the prescheduling parameters 322 can also adjust the frequency of prescheduled grants for individual wireless devices. The adjustments can be based on device characteristics and current network conditions. For example, wireless devices running latency-sensitive applications or experiencing poor radio conditions can receive more resources in the prescheduled grants. Conversely, wireless devices with less demanding applications or better signal quality can receive less resources in the grants.

In some other embodiments, to avoid sudden performance changes in the network, the system can implement the prescheduling parameters 322 in gradual adjustments over multiple iterations rather than making a large change all at once. For example, the system can limit resource adjustments to no more than 1%-10% of the available resources in a single iteration.

In some embodiments, the system includes an analysis engine 324. The analysis engine 324 analyzes the prescheduling parameters 322 to determine if the prescheduling parameters 322 should be adjusted. The analysis engine compares the prescheduling parameters 322 to historical prescheduling parameters stored in the optimization history 316. The analysis engine determines whether the prescheduling parameters 322 should be adjusted to prevent a possible negative impact to the network KPIs. The analysis engine 324 can be part of the ML model 320, be a separate ML model, or be a separate entity. When the analysis engine 324 determines that an adjustment is required, the ML model 320 generates a new set of prescheduling parameters 322. When the analysis engine 324 determines that an adjustment is not required, the prescheduling parameters 322 are transmitted to the prescheduling control unit 328. The prescheduling control unit 328 controls how the resources are allocated based on the prescheduling parameters 322. The prescheduling control unit 328 implements the prescheduling parameters 322 on the base station 330.

In some embodiments, the system includes a feedback loop to evaluate the outcome of the prescheduling decisions. The system monitors the environment and observes the results of its actions to refine the decision-making process to minimize negative impacts to network KPIs over time. For example, when uplink interference increases beyond a certain threshold, the system can reduce the frequency or amount of resource allocation. Conversely, when latency increases beyond a predetermined threshold, the system can modify the prescheduling for affected devices or QoS classes. Additionally, after implementing the prescheduling parameters 322, the system can revert the prescheduling parameters 322 to a previous configuration if the dynamic adjustment results in KPI degradation. The ability to revert to a previous configuration helps prevent unintended negative impacts on network performance. The system continuously compares current KPI values against historical baselines and predefined thresholds. When significant degradation is detected, the system can roll back to the last known stable configuration while logging the incident for further analysis.

The frequency in which the system updates and performs prescheduling parameter adjustments can be tailored based on available processing power, network characteristics, expected impact on the base station, and/or user preference. For example, the system can update the prescheduling parameters 322 at 5-, 10-, or 15-minute intervals. The ability to monitor and update the network prescheduling enables the optimization of network resources while lowering negative impacts to network KPIs and the user's experience on the telecommunication network.

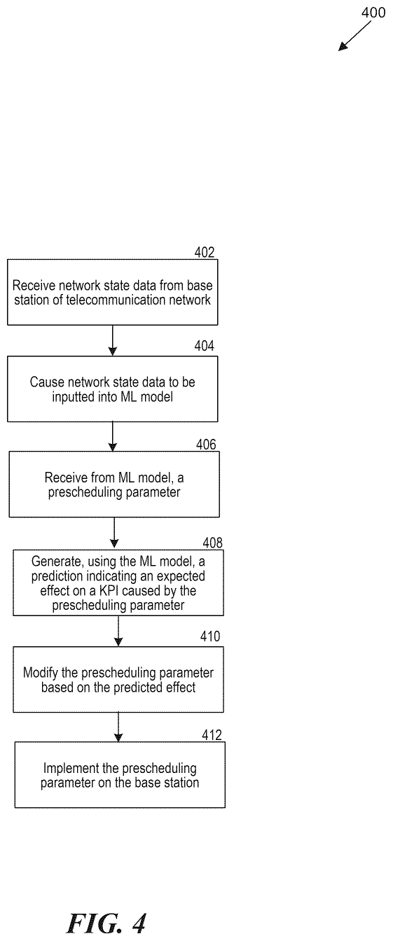

FIG. 4 is a flowchart of a process 400 performed by an embodiment of the system. In one example, the system includes at least one hardware processor and at least one non-transitory memory storing instructions, which, when executed by the at least one hardware processor, cause the system to perform the process 400.

At 402, the system receives network state data from a base station of a telecommunication network. The network state data includes at least one of environmental conditions, wireless device characteristics, a network configuration, or a key performance indicator (KPI). The KPI can include at least one of uplink received signal strength indicator, latency, or call drop rate. In some embodiments, the KPI further includes: jitter, cell-edge performance, spectral efficiency, or network stability. At 404, the system causes the network state data to be inputted into a machine learning (ML) model. The ML model can be trained, using historical network data, to generate at least one prescheduling parameter.

At 406, the system receives, from the ML model, at least one prescheduling parameter. The at least one prescheduling parameter defines a network resource allocation of the base station. In some embodiments, the at least one prescheduling parameter allocates network resources to a network slice of the base station. In some other embodiments, the system determines, using the ML model, a frequency to generate an update to the at least one prescheduling parameter based on an update to the network condition data. The system updates the prescheduling at the frequency determined by the machine learning model.

At 408, the system generates, using the ML model, a prediction indicating an expected effect on the KPI caused by implementing the at least one prescheduling parameter. At 410, the system modifies the at least one prescheduling parameter based on the predicted effect.

At 412, the system implements the at least one prescheduling parameter on the base station to preschedule network resources on the base station. In some embodiments, the system determines an effect on the KPI caused by prescheduling the network resources on the base station. The system generates, using the ML model, a second prescheduling parameter based on the effect on the KPI. In some other embodiments, the system disables, based on the prescheduling parameter, access to the prescheduled network resources by a wireless device type connected to the base station of the telecommunication network. In yet some other embodiments, the system preschedules a predetermined portion of the network resources allocated by the prescheduling parameter. The system analyzes an effect on the KPI caused by prescheduling the network resources on the base station. The system preschedules a remaining portion of network resources allocated by the prescheduling parameter based on the effect on the KPI being below a threshold amount.

### Computer System

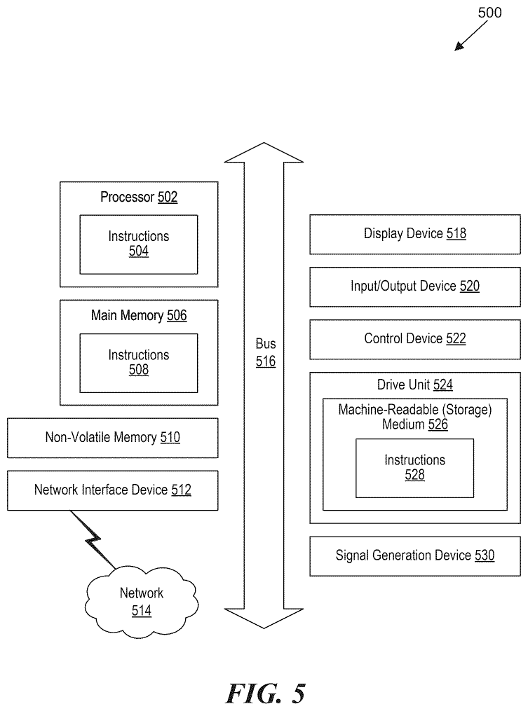

FIG. 5 is a block diagram that illustrates an example of a computer system 500 in which at least some operations described herein can be implemented. As shown, the computer system 500 can include: one or more processors 502, main memory 506, non-volatile memory 510, a network interface device 512, a video display device 518, an input/output device 520, a control device 522 (e.g., keyboard and pointing device), a drive unit 524 that includes a machine-readable (storage) medium 526, and a signal generation device 530 that are communicatively connected to a bus 516. The bus 516 represents one or more physical buses and/or point-to-point connections that are connected by appropriate bridges, adapters, or controllers. Various common components (e.g., cache memory) are omitted from FIG. 5 for brevity. Instead, the computer system 500 is intended to illustrate a hardware device on which components illustrated or described relative to the examples of the figures and any other components described in this specification can be implemented.

The computer system 500 can take any suitable physical form. For example, the computing system 500 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 500. In some implementations, the computer system 500 can be an embedded computer system, a system-on-chip (SOC), a single-board computer system (SBC), or a distributed system such as a mesh of computer systems, or it can include one or more cloud components in one or more networks. Where appropriate, one or more computer systems 500 can perform operations in real time, in near real time, or in batch mode.

The network interface device 512 enables the computing system 500 to mediate data in a network 514 with an entity that is external to the computing system 500 through any communication protocol supported by the computing system 500 and the external entity. Examples of the network interface device 512 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 506, non-volatile memory 510, machine-readable medium 526) can be local, remote, or distributed. Although shown as a single medium, the machine-readable medium 526 can include multiple media (e.g., a centralized/distributed database and/or associated caches and servers) that store one or more sets of instructions 528. The machine-readable medium 526 can include any medium that is capable of storing, encoding, or carrying a set of instructions for execution by the computing system 500. The machine-readable medium 526 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory 510, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 504, 508, 528) set at various times in various memory and storage devices in computing device(s). When read and executed by the processor 502, the instruction(s) cause the computing system 500 to perform operations to execute elements involving the various aspects of the disclosure.

### Machine Learning Model

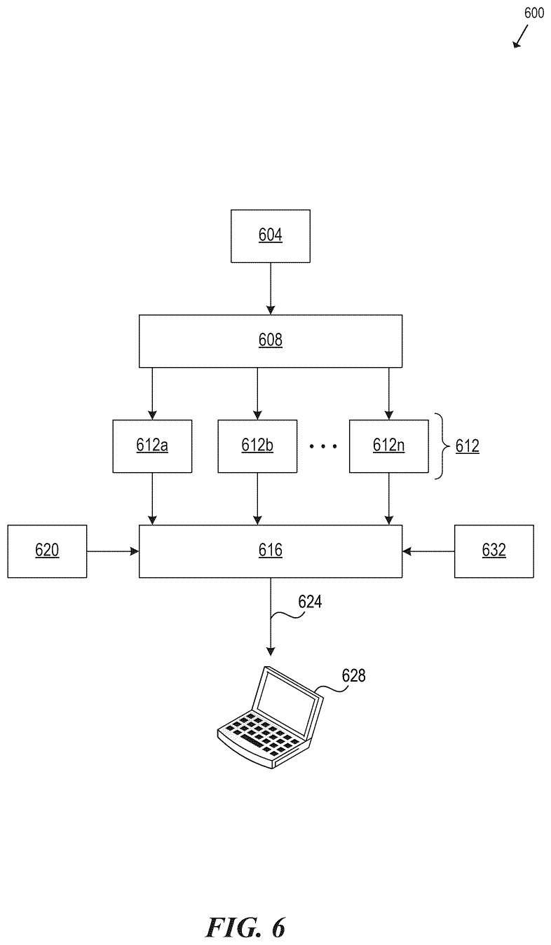

FIG. 6 is a block diagram illustrating an example ML system 600, in accordance with one or more embodiments. Likewise, different embodiments of the ML system 600 include different and/or additional components and are connected in different ways. The ML system 600 is sometimes referred to as an ML module.

The ML system 600 includes a feature extraction module 608 implemented using components of the example computer system 500 illustrated and described in more detail with reference to FIG. 5. In some embodiments, the feature extraction module 608 extracts a feature vector 612 from input data 604. The feature vector 612 includes features 612a, 612b,. 612n. The feature extraction module 608 reduces the redundancy in the input data 604, for example, repetitive data values, to transform the input data 604 into the reduced set of features 612, for example, features 612a, 612b, . . . 612n. The feature vector 612 contains the relevant information from the input data 604, such that events or data value thresholds of interest are identified by the ML model 616 by using a reduced representation. In some example embodiments, the following dimensionality reduction techniques are used by the feature extraction module 608: independent component analysis, Isomap, kernel principal component analysis (PCA), latent semantic analysis, partial least squares, PCA, multifactor dimensionality reduction, nonlinear dimensionality reduction, multilinear PCA, multilinear subspace learning, semidefinite embedding, autoencoder, and deep feature synthesis.

In alternate embodiments, the ML model 616 performs deep learning (also known as deep structured learning or hierarchical learning) directly on the input data 604 to learn data representations, as opposed to using task-specific algorithms. In deep learning, no explicit feature extraction is performed; the features 612 are implicitly extracted by the ML system 600. For example, the ML model 616 uses a cascade of multiple layers of nonlinear processing units for implicit feature extraction and transformation. Each successive layer uses the output from the previous layer as input. The ML model 616 thus learns in supervised (e.g., classification) and/or unsupervised (e.g., pattern analysis) modes. The ML model 616 learns multiple levels of representations that correspond to different levels of abstraction, wherein the different levels form a hierarchy of concepts. The multiple levels of representation configure the ML model 616 to differentiate features of interest from background features.

In alternative example embodiments, the ML model 616, for example, in the form of a convolutional neural network (CNN), generates the output 624, without the need for feature extraction, directly from the input data 604. The output 624 is provided to the computer device 628. The computer device 628 is a server, computer, tablet, smartphone, smart speaker, etc., implemented using components of the example computer system 500 illustrated and described in more detail with reference to FIG. 5. In some embodiments, the steps performed by the ML system 600 are stored in memory on the computer device 628 for execution. In other embodiments, the output 624 is displayed on an electronic display of the computer device 628.

A CNN is a type of feed-forward artificial neural network in which the connectivity pattern between its neurons is inspired by the organization of a visual cortex. Individual cortical neurons respond to stimuli in a restricted area of space known as the receptive field. The receptive fields of different neurons partially overlap such that they tile the visual field. The response of an individual neuron to stimuli within its receptive field is approximated mathematically by a convolution operation. CNNs are based on biological processes and are variations of multilayer perceptrons designed to use minimal amounts of preprocessing.

In embodiments, the ML model 616 is a CNN that includes both convolutional layers and max pooling layers. For example, the architecture of the ML model 616 is “fully convolutional,” which means that variable-sized sensor data vectors are fed into it. For convolutional layers, the ML model 616 specifies a kernel size, a stride of the convolution, and an amount of zero padding applied to the input of that layer. For the pooling layers, the ML model 616 specifies the kernel size and stride of the pooling.

In some embodiments, the ML system 600 trains the ML model 616, based on the training data 620, to correlate the feature vector 612 to expected outputs in the training data 620. As part of the training of the ML model 616, the ML system 600 forms a training set of features and training labels by identifying a positive training set of features that have been determined to have a desired property in question, and, in some embodiments, forms a negative training set of features that lack the property in question.

The ML system 600 applies ML techniques to train the ML model 616, that when applied to the feature vector 612, outputs indications of whether the feature vector 612 has an associated desired property or properties, such as a probability that the feature vector 612 has a particular Boolean property, or an estimated value of a scalar property. In embodiments, the ML system 600 further applies dimensionality reduction (e.g., via linear discriminant analysis (LDA), PCA, or the like) to reduce the amount of data in the feature vector 612 to a smaller, more representative set of data.

In embodiments, the ML system 600 uses supervised ML to train the ML model 616, with feature vectors of the positive training set and the negative training set serving as the inputs. In some embodiments, different ML techniques, such as linear support vector machine (linear SVM), boosting for other algorithms (e.g., AdaBoost), logistic regression, naïve Bayes, memory-based learning, random forests, bagged trees, decision trees, boosted trees, boosted stumps, neural networks, CNNs, etc., are used. In some example embodiments, a validation set 632 is formed of additional features, other than those in the training data 620, which have already been determined to have or to lack the property in question. The ML system 600 applies the trained ML model 616 to the features of the validation set 632 to quantify the accuracy of the ML model 616. Common metrics applied in accuracy measurement include Precision and Recall, where Precision refers to a number of results the ML model 616 correctly predicted out of the total it predicted, and Recall is a number of results the ML model 616 correctly predicted out of the total number of features that had the desired property in question. In some embodiments, the ML system 600 iteratively re-trains the ML model 616 until the occurrence of a stopping condition, such as the accuracy measurement indication that the ML model 616 is sufficiently accurate, or a number of training rounds having taken place. In embodiments, the validation set 632 includes data corresponding to confirmed locations, dates, times, activities, or combinations thereof. This allows the detected values to be validated using the validation set 632. The validation set 632 is generated based on the analysis to be performed.

### Remarks

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not for other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense—that is to say, in the sense of “including, but not limited to.” As used herein, the terms “connected,” “coupled,” and any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

I/We claim:

1. A non-transitory, computer-readable storage medium comprising instructions recorded thereon, wherein the instructions, when executed by at least one data processor of a system, cause the system to:
receive network state data from a base station of a telecommunication network,
wherein the network state data includes at least one of environmental conditions, wireless device characteristics, a network configuration, or a key performance indicator (KPI), and
wherein the KPI includes at least one of uplink received signal strength indicator, latency, or call drop rate;
cause the network state data to be inputted into a machine learning (ML) model,
wherein the ML model is trained, using historical network data, to generate at least one prescheduling parameter;
receive, from the ML model, at least one prescheduling parameter,
wherein the at least one prescheduling parameter defines a network resource allocation of the base station;
generate, using the ML model, a prediction indicating an effect on the KPI caused by implementing the at least one prescheduling parameter;
modify the at least one prescheduling parameter based on the predicted effect; and
implement the at least one prescheduling parameter on the base station to preschedule network resources on the base station.

2. The non-transitory, computer-readable storage medium of claim 1, wherein the system is further caused to:
determine an effect on the KPI caused by prescheduling the network resources on the base station; and
generate, using the ML model, a second prescheduling parameter based on the effect on the KPI.

3. The non-transitory, computer-readable storage medium of claim 2, wherein the KPI further includes:
jitter,
cell-edge performance,
spectral efficiency, or
network stability.

4. The non-transitory, computer-readable storage medium of claim 1, wherein the at least one prescheduling parameter allocates network resources to a network slice of the base station.

5. The non-transitory, computer-readable storage medium of claim 1, wherein the system is further caused to:
disable, based on the at least one prescheduling parameter, access to the prescheduled network resources by a wireless device type connected to the base station of the telecommunication network.

6. The non-transitory, computer-readable storage medium of claim 1, wherein the system is further caused to:
preschedule a predetermined portion of the network resources allocated by the at least one prescheduling parameter;
analyze an effect on the KPI caused by prescheduling the network resources on the base station; and
preschedule a remaining portion of network resources allocated by the at least one prescheduling parameter based on the effect on the KPI being below a threshold amount.

7. The non-transitory, computer-readable storage medium of claim 1, wherein the system is further caused to:
determine, using the ML model, a frequency to generate an update to the at least one prescheduling parameter based on an update to the network state data; and
update the prescheduling at the frequency determined by the ML model.

8. A system comprising:
at least one hardware processor; and
at least one non-transitory memory storing instructions, which, when executed by the at least one hardware processor, cause the system to:
receive network state data from a base station of a telecommunication network,
wherein the network state data includes at least one of environmental conditions, wireless device characteristics, a network configuration, or a key performance indicator (KPI);
cause the network state data to be inputted into a machine learning (ML) model,
wherein the ML model is trained, using historical network data, to generate at least one prescheduling parameter;
receive, from the ML model, at least one prescheduling parameter,
wherein the at least one prescheduling parameter defines a network resource allocation of the base station; and
implement the at least one prescheduling parameter on the base station to preschedule network resources on the base station.

9. The system of claim 8, further caused to:
determine an effect on the KPI caused by prescheduling the network resources on the base station; and
generate, using the ML model, a second prescheduling parameter based on the effect on the KPI.

10. The system of claim 8, wherein the KPI includes:
uplink received signal strength indicator,
latency,
jitter,
call drop rate,
cell-edge performance,
spectral efficiency, or
network stability.

11. The system of claim 8, wherein the at least one prescheduling parameter allocates network resources to a network slice of the base station.

12. The system of claim 8, further caused to:
disable, based on the at least one prescheduling parameter, access to the prescheduled network resources by a wireless device type connected to the base station of the telecommunication network.

13. The system of claim 8, further caused to:
preschedule a predetermined portion of the network resources allocated by the at least one prescheduling parameter;
analyze an effect on the KPI caused by prescheduling the network resources on the base station; and
preschedule a remaining portion of network resources allocated by the at least one prescheduling parameter based on the effect on the KPI being below a threshold amount.

14. The system of claim 8, further caused to:
determine, using the ML model, a frequency to generate an update to the at least one prescheduling parameter based on an update to the network state data; and
update the prescheduling at the frequency determined by the ML model.

15. The system of claim 8, further caused to:
generate, using the ML model, a prediction indicating an effect on the KPI caused by implementing the at least one prescheduling parameter; and
modify the at least one prescheduling parameter based on the predicted effect.

16. A method comprising:
receiving network state data from a base station of a telecommunication network,
wherein the network state data includes at least one of environmental conditions, wireless device characteristics, a network configuration, or a key performance indicator (KPI);
causing the network state data to be inputted into a machine learning (ML) model,
wherein the ML model is trained, using historical network data, to generate at least one prescheduling parameter;
receiving, from the ML model, at least one prescheduling parameter,
wherein the at least one prescheduling parameter defines a network resource allocation of the base station; and
implementing the at least one prescheduling parameter on the base station to preschedule network resources on the base station.

17. The method of claim 16, further comprising:
determining an effect on the KPI caused by prescheduling the network resources on the base station; and
generating, using the ML model, a second prescheduling parameter based on the effect on the KPI.

18. The method of claim 16, wherein the KPI includes:
uplink received signal strength indicator,
latency,
jitter,
call drop rate,
cell-edge performance,
spectral efficiency, or
network stability.

19. The method of claim 16, further comprising:
prescheduling a predetermined portion of the network resources allocated by the at least one prescheduling parameter;
analyzing an effect on the KPI caused by prescheduling the network resources on the base station; and
prescheduling a remaining portion of network resources allocated by the at least one prescheduling parameter based on the effect on the KPI being below a threshold amount.

20. The method of claim 16, further comprising:
generating, using the ML model, a prediction indicating an effect on the KPI caused by implementing the at least one prescheduling parameter; and
modifying the at least one prescheduling parameter based on the predicted effect.
